(19) United States
(12) Patent Application Publication
(10) Pub. No.: US 2002/0135316 A1
(43) Pub. Date: Sep. 26, 2002

(54) Capacitively coupled fluorescent lamp package

(75) Inventors: Gert Bruning, Sleepy Hollow, NY (US); Chin Chang, Yorktown Heights, NY (US)

Correspondence Address: Dilworth & Barrese, LLP, 333 Earle Ovington Blvd., Uniondale, NY, 11553, US

(73) Assignee: Philips Electronics North America Corp.

(21) Appl. No.: 09/814,603

(22) Filed: Mar. 22, 2001

(51) Int. Cl. H05B 37/02

(52) U.S. Cl. 315/219; 315/224

(57) ABSTRACT

A capacitively coupled fluorescent lamp package having a capacitively coupled fluorescent lamp having cylindrical ceramic tubes is disclosed. The lamp package further includes an electronic driver or inverter circuit for driving the lamp and supply nodes for receiving a supply voltage. The inverter circuit is a conventional inverter circuit, such as, for example, current-fed push-pull, voltage-fed push-pull, active clamped Flyback, and voltage-fed half-bridge inverter circuits, used in conventional CCFLs. A ballast circuit may be connected to the inverter circuit for properly ballasting the lamp.

### BACKGROUND OF THE INVENTION

1. Technical Field

The present disclosure relates generally to lighting systems. More specifically, the present disclosure relates to a capacitively coupled fluorescent lamp package having a capacitively coupled fluorescent lamp and an inverter circuit.

2. Background of the Related Art

Cold cathode fluorescent lamps (CCFL) are widely used to backlight liquid crystal displays (LCD) and for other applications. Different electronic drivers or inverter circuits, for example, current-fed push-pull, voltage-fed push-pull, active clamped Flyback, and voltage-fed half-bridge inverter circuits, have been designed to operate CCFL lamps in high operating frequencies. A typical frequency range is between 20 kHz and 100 kHz. In this way a high frequency voltage is applied in a discharge space within a discharge vessel or tube of the CCFL forming a discharge.

To increase the illuminance of the CCFL, the gas pressure of the rare gas which fills the discharge vessel or tube is increased. After increasing the gas pressure of the rare gas, the current required for discharge is not sufficient if the voltage applied to the CCFL and the high frequency of the voltage are not increased. Therefore, in order to increase the illuminance or lamp power of the CCFL, not only must the gas pressure of the rare gas be increased, but also the voltage and current applied to the CCFL. However, when the applied voltage is increased, there is the danger of discharge creeping on the outer surface of the discharge vessel which can lead to an insulation breakdown of the CCFL.

To overcome the disadvantages of conventional CCFLs, a capacitively coupled fluorescent lamp has been designed where the traditional cathodes (composed of two relatively heavy nickel-plated iron rectangular tabs forming a “V”) are replaced by cylindrical ceramic tubes or capacitive coupling structures. Typically, the cylindrical ceramic tubes have an inner diameter of 2.5 mm, an outer diameter of 3.5 mm and a length of 10 mm. Such ceramic tubes with certain dielectric constant and geometry effectively form series capacitance with the positive column of the lamp. The capacitance is not dependent on frequency. With proper material selection and construction, such series capacitance could be designed for the benefit of the electronic driver.

Due to the improvement of the cathodes, the lamp current is increased dramatically, without having to increase the pressure of the filled gas and the voltage applied to the lamp. In fact, when compared to conventional CCFLs, to deliver the same lamp power, the voltage applied to the capacitively coupled fluorescent lamp is less than the voltage applied to conventional CCFLs.

Further, as an effect, the equivalent lamp impedance is greatly reduced. For example, in a preferred design for the capacitively coupled fluorescent lamp, the lamp voltage is 450 V and the lamp current is 20 mA at 50 kHz. Hence, the lamp impedance is approximately 22.5 kOhm compared with approximately 115 Kohm for conventional CCFLs. Therefore, the capacitively coupled fluorescent lamp overcomes the problems associated with the prior art and also offers several advantages over conventional CCFLs.

There is a need to improve the capacitively coupled fluorescent lamp to provide a capacitively coupled fluorescent lamp package which is designed for installation in an electrical device, especially within an electrical device having an LCD display which requires backlighting.

### SUMMARY OF THE INVENTION

In accordance with the present disclosure, a capacitively coupled fluorescent lamp package is provided which obviates the problems associated with the prior art.

The disclosed capacitively coupled fluorescent lamp package includes a capacitively coupled fluorescent lamp having cylindrical ceramic tubes. The lamp package further includes an electronic driver or inverter circuit for driving the lamp and supply nodes for receiving a supply voltage. The inverter circuit is a conventional inverter circuit, such as, for example, current-fed push-pull, voltage-fed push-pull, active clamped Flyback, and voltage-fed half-bridge inverter circuits, used in conventional CCFLs.

Specifically, the present disclosure provides a capacitively coupled fluorescent lamp package including a capacitively coupled fluorescent lamp; an inverter circuit for driving the lamp; and supply nodes for receiving a supply voltage. A ballast circuit controlled by an integrated circuit may be connected to the inverter circuit for properly ballasting the lamp.

The present disclosure further provides a method for manufacturing a capacitively coupled fluorescent lamp package. The method includes the steps of providing a capacitively coupled fluorescent lamp; providing an inverter circuit for driving the lamp; and providing supply nodes for applying a supply voltage to the inverter circuit. The method further includes the step of providing a housing for fully enclosing the lamp, the inverter circuit and partially enclosing the supply nodes.

### BRIEF DESCRIPTION OF THE DRAWINGS

FIG. 1 illustrates a prior art capacitively coupled fluorescent lamp;

FIG. 2 is a block diagram of a capacitively coupled fluorescent lamp package according to the present disclosure;

FIG. 3 is a schematic diagram of a voltage-fed half-bridge inverter circuit driving the capacitively coupled fluorescent lamp; and

FIG. 4 is a block diagram of an alternate capacitively coupled fluorescent lamp package according to the present disclosure.

### DETAILED DESCRIPTION OF PREFERRED EMBODIMENTS

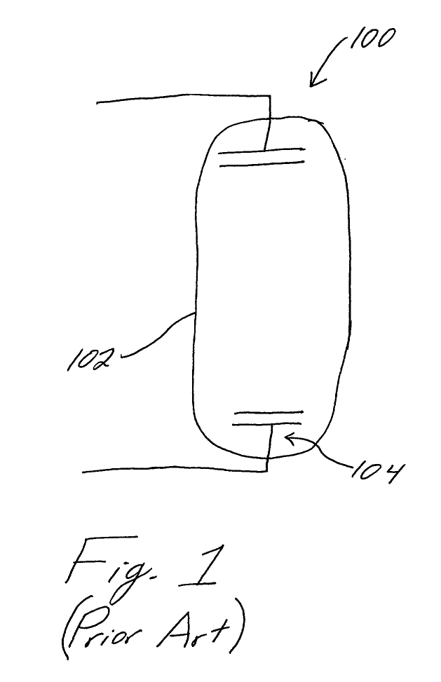

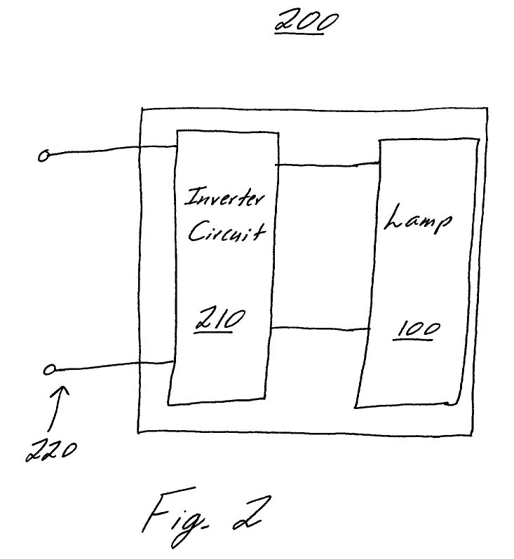

A preferred embodiment of the presently disclosed capacitively coupled fluorescent lamp package will now be described in detail with reference to FIGS. 1 and 2. While the embodiment disclosed herein is designed for backlighting a liquid crystal display (LCD), the presently disclosed embodiment can be used in other applications.

With reference to FIG. 1, there is shown a prior art capacitively coupled fluorescent lamp designated generally by reference numeral 100. The capacitively coupled fluorescent lamp 100 includes a discharge vessel or tube 102 and cylindrical ceramic tubes or capacitive coupling structures 104, instead of the conventional cathodes, within the discharge vessel 102. Typically, the cylindrical ceramic tubes 104 have an inner diameter of approximately 2.5 mm, an outer diameter of approximately 3.5 mm and a length of approximately 10 mm.

The cylindrical ceramic tubes 104 of the capacitively coupled fluorescent lamp 100 cause the current applied to the lamp 100 to increase by approximately 100% without having to increase the pressure of the filled gas within a discharge vessel or tube 106 and the voltage applied to the lamp 100.

In a preferred design for the capacitively coupled fluorescent lamp 100, the lamp voltage is approximately 450 V. Further, the lamp current is approximately 20 mA at an operating frequency of approximately 50 kHz. Hence, the lamp impedance is approximately 22.5 kOhm compared with approximately 115 Kohm for conventional CCFLs.

With reference to FIG. 2, there is shown a block diagram of a capacitively coupled fluorescent lamp package according to the present disclosure. The capacitively coupled fluorescent lamp package designated generally by reference numeral 200 includes the capacitively coupled fluorescent lamp 100 having the discharge vessel 102 and cylindrical ceramic tubes 104. The lamp package 200 further includes an electronic driver or inverter circuit 210 for driving the lamp 100 and supply nodes 220 for receiving a supply voltage from a voltage or power supply (not shown). The supply voltage is approximately 450 V. Preferably, the inverter circuit 210 supplies a 20 kHz and 100 kHz driving signal to the capacitively coupled fluorescent lamp 100.

The inverter circuit 210 is a conventional inverter circuit, such as, for example, current-fed push-pull, voltage-fed push-pull, active clamped Flyback, and voltage-fed half-bridge inverter circuits, used in conventional CCFLs.

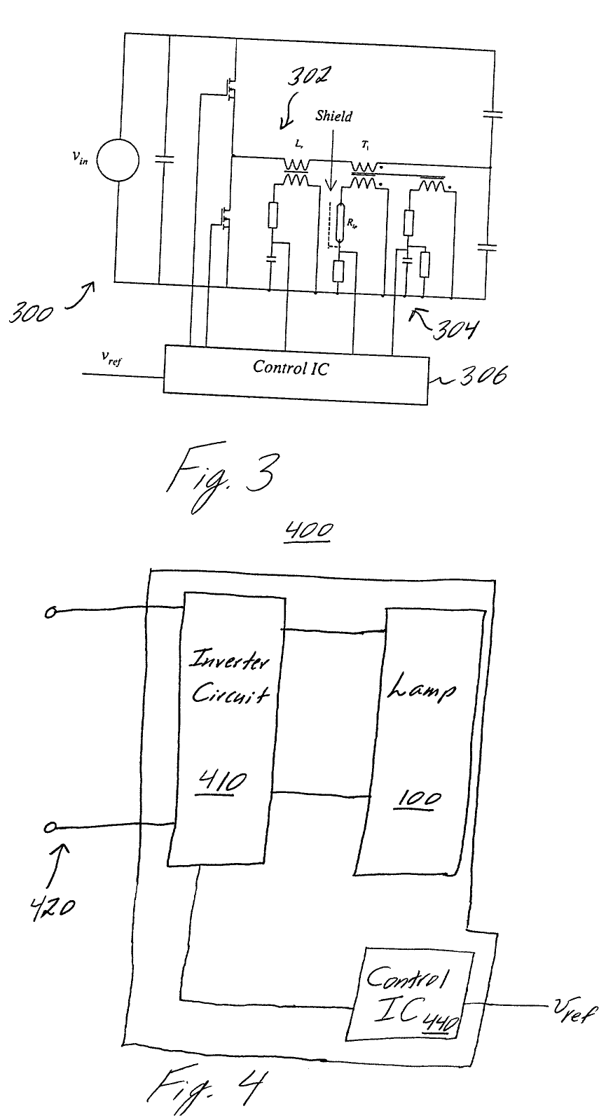

One preferred inverter circuit for incorporation within the lamp package 200 is the voltage-fed half-bridge inverter circuit as shown by FIG. 3 and designated generally by reference numeral 300. The inverter circuit 300 is operated by an input voltage vᵢₙ and includes an LC resonant tank 302 having a resonant inductor Lr. A resonant capacitor is formed by the equivalent shield parasitic capacitance and the equivalent output interwinding capacitance of transformer T1. The capacitively coupled fluorescent lamp 100 is denoted by its equivalent Rlp. A ballast circuit 304 is included for ballasting the lamp 100. The ballast circuit 304 is controlled by an integrated circuit 306 which is operated by a reference voltage v_{ref}.

With reference to FIG. 4, there is shown a block diagram of an alternate embodiment of the capacitively coupled fluorescent lamp package according to the present disclosure. The capacitively coupled fluorescent lamp package designated generally by reference numeral 400 is similar to the lamp package 200 described above. Accordingly, the lamp package 400 includes the capacitively coupled fluorescent lamp 100 having the discharge vessel 102 and cylindrical ceramic tubes 104.

The lamp package 400 further includes an electronic driver or inverter circuit 410 for driving the lamp 100 and supply nodes 420 for receiving a supply voltage from a voltage or power supply (not shown). The supply voltage of the lamp package 400 is approximately 450 V. Preferably, the inverter circuit 410 supplies a 20 kHz and 100 kHz driving signal to the capacitively coupled fluorescent lamp 100.

The lamp package 400 further includes a ballast circuit within the inverter circuit 410 for ballasting the lamp 100. The ballast circuit is preferably controlled by an integrated circuit 440 operated by a reference voltage v_{ref} as described above with reference to FIG. 3.

In backlighting an LCD, the lamp package 200 is installed within a system having the LCD, such as a laptop computer, and the supply nodes 220 are connected to the voltage or power supply for providing a supply voltage. The inverter circuit 210 is then powered by the supply voltage. Accordingly, the inverter circuit 210 transmits drive signals to the capacitively coupled fluorescent lamp 100 causing the lamp 100 to achieve luminance for backlighting the LCD.

The present disclosure also provides a method for manufacturing the capacitively coupled fluorescent lamp packages 200, 400. The method includes the steps of providing a capacitively coupled fluorescent lamp 100; providing an inverter circuit, such as the inverter circuits 210, 410, for driving the lamp 100; and providing supply nodes, such as supply nodes 220, 420, for applying a supply voltage to the inverter circuit.

It is contemplated to also provide a housing for fully enclosing the lamp 100, the inverter circuit and partially enclosing the supply nodes. It is also contemplated to provide a ballast circuit, such as ballast circuit 430, for ballasting the capacitively coupled fluorescent lamp 100 and to provide an integrated circuit, such as integrated circuit 440, for controlling the ballast circuit.

Preferably, the inverter circuit is selected from the group consisting of current-fed push-pull, voltage-fed push-pull, active clamped Flyback, and voltage-fed half-bridge inverter circuits.

It will be understood that various modifications may be made to the embodiments disclosed herein and that the above description should not be construed as limiting, but merely as exemplifications of preferred embodiments. Those skilled in the art will envision other modifications within the scope and spirit of the claims appended hereto.

What is claimed is:

1. A capacitively coupled fluorescent lamp package comprising:
a capacitively coupled fluorescent lamp;
an inverter circuit for driving the lamp; and
supply nodes for receiving a supply voltage.

2. The lamp package according to claim 1, wherein the inverter circuit is selected from the group consisting of current-fed push-pull, voltage-fed push-pull, active clamped Flyback, and voltage-fed half-bridge inverter circuits.

3. The lamp package according to claim 1, wherein the capacitively coupled fluorescent lamp includes a discharge vessel and cylindrical ceramic tubes within the discharge vessel.

4. The lamp package according to claim 3, wherein the cylindrical ceramic tubes 104 have an inner diameter of approximately 2.5 mm, an outer diameter of approximately 3.5 mm and a length of approximately 10 mm.

5. The lamp package according to claim 1, wherein the inverter circuit supplies a 20 kHz and 100 kHz driving signal to the capacitively coupled fluorescent lamp.

6. The lamp package according to claim 1, wherein the supply voltage is approximately 450 V.

7. The lamp package according to claim 1, wherein the capacitively coupled fluorescent lamp has a lamp current of approximately 20 mA and an operating frequency of approximately 50 kHz.

8. The lamp package according to claim 1, wherein the capacitively coupled fluorescent lamp has a lamp impedance of approximately 22.5 kOhm.

9. The lamp package according to claim 1, further comprising a ballast circuit for ballasting the capacitively coupled fluorescent lamp.

10. The lamp package according to claim 1, further comprising an integrated circuit for controlling the ballast circuit.

11. A method for manufacturing a capacitively coupled fluorescent lamp package, the method comprising the steps of:
providing a capacitively coupled fluorescent lamp;
providing an inverter circuit for driving the lamp; and
providing supply nodes for applying a supply voltage to the inverter circuit.

12. The method according to claim 11, further comprising the step of providing a housing for fully enclosing the lamp, the inverter circuit and partially enclosing the supply nodes.

13. The method according to claim 11, further comprising the steps of:
providing a ballast circuit for ballasting the capacitively coupled fluorescent lamp; and
providing an integrated circuit for controlling the ballast circuit.

14. The method according to claim 11, further comprising the step of selecting the inverter circuit from the group consisting of current-fed push-pull, voltage-fed push-pull, active clamped Flyback, and voltage-fed half-bridge inverter circuits.
